(19) United States
(12) Patent Application Publication
(10) Pub. No.: US 2026/0210435 A1
(43) Pub. Date: Jul. 23, 2026

(54) POWER TRANSMISSION SYSTEM

(71) Applicant: Master Power Transmission, Inc., Greenville, SC (US)

(72) Inventor: Chris C. Sewell, Columbus, IN (US)

(21) Appl. No.: 19/455,068

(22) Filed: Jan. 21, 2026

Related U.S. Application Data
(60) Provisional application No. 63/747,647, filed on Jan. 21, 2025.

(51) Int. Cl. F16H 57/021; F16H 1/20; F16H 57/023; F16H 57/031

(52) U.S. Cl. CPC F16H 57/021; F16H 1/20; F16H 57/023; F16H 57/031

(57) ABSTRACT

A power transmission system having a gearbox having an input shaft and a gear train in geared communication with the input shaft and a single-tapered hub that is configured for selectively coupling or locking a bushing relative to a backing plate when the bushing and driven output shaft are placed into complementary engagement with the hub of the gearbox in an engaged position. In the engaged position, the constrained position of the bushing relative to the backing plate acts to axially constrain movement of the operable coupled driven output shaft, bushing, and backing plate relative to the hub while allowing for direct and synchronous rotation of the driven output shaft in response to rotation of the hub of the gear box.

### CROSS-REFERENCE TO RELATED APPLICATION

The present application claims priority to U.S. Provisional Patent Application No. 63/747,647, filed Jan. 21, 2025, which application is hereby specifically incorporated by reference as if presented herein in their entirety.

### TECHNICAL FIELD

The present disclosure relates generally to the field of power transmission systems, such as gear reducer systems employing hubs and shafts coupled to one another for input or output of torque. More particularly, the invention relates to a technique facilitating assembly and disassembly of shafts mounted in support hubs, such as an output hub of a gear reducer or similar equipment.

### BACKGROUND

As one will appreciate, a wide range of applications exist for rotary drive systems, throughout all aspects of industry, material handling, agriculture, and transportation, to mention just a few fields. In general, many such systems are based upon the generation of rotary motion that is transmitted to various machine elements through couplings, gear drives, transmissions, and so forth. In systems where a prime mover, such as an electric motor or an internal combustion engine, rotates at a speed other than that desired at the actual application, gear reducers or variable speed drives are typically employed to reduce or increase the speed and torque to the desired range.

Generally, input and output elements of power transmission components must interface with one another to transmit mechanical power reliably and to withstand loading likely to be encountered in use. Such input and output elements in such rotary drive systems is often provided by rotating shafts that are configured to be coupled to one another via couplings, sheaves, belts, or similar techniques. In specific applications, however, it is known to interface a shaft within a hub designed to receive the shaft and to transmit power either from the shaft to the hub or vice versa. For example, conventional gear reducers can have an input shaft and an output hub or quill that are internally coupled to one another via intermeshing gears and pinions. In this example, a machine can be configured to be secured firmly to an output shaft that is configured to be operably coupled to a portion of the output hub.

A range of coupling and support configurations have been designed and are presently in use for ensuring reliable power transmission in such arrangements, while offering resistance to additional loading provided by the coupling system itself. For example, in one conventional mounting and coupling arrangement for rotational power transmission systems, a tapered bushing is inserted between a portion of an output shaft and a portion of a hub to operatively selectively lock the output shaft and hub with respect to one another such that the coupled output shaft and hub can rotate about a common machine axis in sync when the system is fully assembled. In this example, the tapered bushing in configured to interface directly with a corresponding tapered portion of the hub and a portion of the exterior surface of the driven output shaft and is generally wedged axially into tight engagement therebetween by axial displacement of at least one of the driven output shaft, the bushing, and/or the backing plate.

While mounting and coupling arrangements of the type described above provide excellent power transmission capabilities and good mechanical support, they are not without drawbacks. For example, in hub-mounted gear reducers systems, tapered bushings may be pressed between the hub and the shaft during assembly, or the shaft may be directly interfaced with a tapered portion of the hub at one end. Flanged arrangements with threaded fasteners are then typically employed for forcing tight engagement of the tapered surfaces with one another. For subsequent servicing, however, the tight engagement of the tapered surfaces, and the tight wedged engagement of the tapered bushing between the shaft and hub make disassembly extremely time consuming and difficult. In practice, various hand tools, hoists, pullers, and the like may be employed to attempt to separate the machine elements from one another, sometimes resulting in damage or destruction of one or more of the elements, leading to additional down time and cost.

There is a need, therefore, for an improved technique for assembling and disassembling mechanical components such as a hub and shaft. There is, at present, a particular need for a simple and straightforward system which can be retrofitted into existing power transmission systems or installed in new systems to facilitate both assembly and disassembly. Such a technique would advantageously build from certain existing product configurations, reducing the overall system redesign, particularly in retrofitted systems.

### SUMMARY

To improve the state of the art, disclosed herein is a power transmission system, and methods of use thereof, utilizing novel features and functionalities.

The invention provides a novel system and method for assembling hubs of a gearbox and driven output shafts in mechanical power transmission systems designed to respond to these needs. The disclosed method employs a single-taper quill or hub that is operably mounted therein a gearbox. In operation, a bushing can be positioned on a distal portion of a driven output shaft and, subsequently, a tapered body portion of the bushing and the distal portion of the driven output shaft can be inserted into an interior hub bore that extends therethrough the hub along a machine axis of the hub to complementarily interface with the proximal taper portion of the bore of the hub.

The proximal taper portion of the hub bore of the single-taper hub has an interior wall that is tapered inwardly from the proximal end of the hub until reaching a first uniform diameter portion of the hub bore of the hub. In embodiments, the hub bore of the hub can further include a second uniform diameter portion of the hub bore that extends from the first uniform diameter portion of the hub bore to the distal end of the hub.

In embodiments, the tapered body portion of the bushing and the distal portion of the driven output shaft can be drawn into engagement with the proximal taper portion of the bore of the hub by use of a backing plate that is configured to complementarily interface with a threaded portion of the exterior surface of the proximal end of the hub for selective axial movement of the backing plate relative to the proximal end of the hub. Means can further be included to selectively fix the backing plate and the bushing into a desired fixed position relative to the hub. In operation, the backing plate forms a low-profile structure which can facilitate reduction of overhung loads in the power transmission arrangement.

The technique facilitates uncoupling and removal of the bushing and driven output shaft from the hub in a straightforward manner. In one arrangement, the backing plate can be selectively rotated about the threaded portion of the exterior surface of the proximal end of the single-taper hub to move the backing plate proximally and axially toward a proximal end of the threaded portion of the exterior surface of the proximal end of the hub, which allows for the coupled backing plate and bushing to be urged out of engagement with the tapered portion of the bore of the hub upon removal of the coupled backing plate, bushing, and driven output shaft.

In an optional arrangement, upon removal of a plurality of fasteners connecting the backing plate to a flange positioned at the proximal end of the bushing, the bushing and the driven output shaft can be selectively axially withdrawn from the bore of the hub, which allows for the bushing and the driven output shaft to be urged out of engagement with the tapered portion of the bore of the hub upon removal of the coupled bushing and driven output shaft.

In operation, it is contemplated that the functionality of the system and method can be reversible, such that it serves to maintain the system in tension during normal operation, while supporting removal of the fasteners for removal of the driven output shaft and hub for servicing. The system thus permits an exemplary single-taper quill and hub to be solidly supported during use and subsequently removed from one another in a simple and controlled manner when desired.

Still other aspects, embodiments, and advantages of these exemplary aspects and embodiments, are discussed in detail below. Moreover, it is to be understood that both the foregoing information and the following detailed description are merely illustrative examples of various aspects and embodiments and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale. Dimensions of various features and elements in the drawings can be expanded or reduced to more clearly illustrate the embodiments of the disclosure.

FIG. 1 schematically illustrates an exploded example of a power transmission system showing a gearbox having an input shaft and a gear train in geared communication with the input shaft and a single-tapered hub. Also shown is a driven output shaft having a bushing mounted there around a distal portion of the driven output shaft. The bushing having a flange at the distal end of the bushing that is configured to be received mounted around the distal portion of the driven output shaft. The backing plate being configured for selective mounting to a threaded portion of an exterior surface of the proximal end portion of the hub. Also shown is an optional snap-ring spring member configured to be received within a slot defined within the backing plate at a desired distance from a shoulder of the backing plate. Further shown is an elongated keyway defined in a distal portion of the driven output shaft and a key member that is configured to be received therein the keyway through a slot in a tapered body portion of the bushing such that an upper edge of the key member extends a desired distance therefrom the outer surface of the bushing proximate the keyway.

FIG. 2 schematically illustrates an exploded example of a power transmission system showing a gearbox having an input shaft, a gear train in geared communication with the input shaft and a single-tapered hub. Also shown is a driven output shaft having a bushing mounted there around a distal portion of the driven output shaft. The bushing having a flange at the distal end of the bushing that is mounted thereon the distal portion of the driven output shaft. The backing plate being configured for selective mounting to a threaded portion of an exterior surface of the proximal end portion of the hub. Also shown is an optional ring spring member configured to be received within a slot defined within the backing plate at a desired distance from a shoulder of the backing plate. Further shown is an elongated keyway defined in a distal portion of the driven output shaft and a key member that is configured to be received therein the keyway through a slot in the tapered body portion of the bushing such that an upper edge of the key member extends a desired distance therefrom the outer surface of the tapered body portion of the bushing that is proximate the keyway.

FIG. 3 schematically illustrates optional embodiments of means for selectively coupling or locking the bushing relative to the backing plate when the bushing and driven output shaft are placed into complementary engagement with the hub of the gearbox in the engaged position.

FIG. 4 is a top elevational view of a backing plate of the power transmission system showing the backing plate having a ring shape that has an upper surface and an opposed shoulder surface. The backing plate defining a central bore that extends through the backing plate and has a diameter that allows for the backing plate to be slideably received thereon the distal end portion of the driven output shaft. The backing plate further defining a plurality of mount bores that are spaced about and from the central bore, which extend through the backing plate and are each configured for threaded receipt of a complementary fastener.

FIG. 5 is a bottom side perspective view of the backing plate of FIG. 4 showing the inner surface of the central bore forming a threaded surface that is configured for operative threaded engagement with a complementary threaded surface on the proximal end of the hub. As shown, the plurality of mount bores extend through the backing plate and open thereon the shoulder surface. As further shown, the backing plate has a wall member that is integrally connected to an edge of the backing plate and extends distally to a distal edge. The wall member further defining a second bore that is positioned co-axially relative to the axis of the central bore and that has a diameter that is greater than the diameter of the central bore. The wall member defines a threaded set-screw bore that extends from an outer surface of the wall member to an inner surface of the wall member, which set-screw bore is configured for operative receipt of a complementarily threaded set-screw. Further, the exterior surface of the wall can define one or more fastener features that are adapted for receipt of a conventional fastener tool. Still further, the inner surface of the wall member can define a slot that extends circumferentially in a plane that is positioned transverse to the axis of the central bore of the backing plate and which is configured for receipt of a snap-ring spring member.

FIG. 6 is a bottom elevational view of the backing plate of FIG. 4 showing the central bore and the plurality of mount bores extending through the backing plate to open thereon the shoulder surface. Also shown is the wall member that is integrally connected to an edge of the backing plate and defines a second bore that is positioned co-axially relative to the axis of the central bore and that has a diameter that is greater than the diameter of the central bore. As further shown, the exterior surface of the wall can define one or more fastener features that are adapted for receipt of a conventional fastener tool.

FIG. 7 is a cross-sectional view of the backing plate taken across line 7-7 of FIG. 6, showing the co-axially positioned central bore and second bore and the wall member of the backing plate. The inner surface of the central bore is shown with a threaded surface for operative threaded engagement with a complementary threaded surface on the proximal end of the hub. Further, the inner surface of the wall member can define a slot that extends circumferentially in a plane that is positioned transverse to the axis of the central bore of the backing plate and which is configured for receipt of a snap-ring spring member. Also shown is a threaded set-screw bore that extends from an outer surface of the wall member to an inner surface of the wall member. Further, the exterior surface of the wall is shown with one or more fastener features that are adapted for receipt of a conventional fastener tool.

FIG. 8 is a side perspective view of a bushing of the power transmission system showing a bushing having flange member and an integrally coupled tapered body portion that extends distally therefrom the flange member. The flange member and the inner surface of the tapered body portion defining a bushing bore that is shaped and sized for complementary receipt thereon the distal portion of the driven output shaft. Further, the tapered body portion has an outer surface having a maximum outer diameter proximate the bottom surface of the flange and is configured to taper to a minimum outer diameter at the distal end of the tapered body portion. The outer surface of the tapered body portion is formed at a taper angle that allows for complementary engagement with the proximal portion of the hub bore. The flange member defining a plurality of flange bores that is shaped and sized for complementary receipt of mounting fasteners that are configured to mount thereto the mount bores of the backing plate. Also shown, the tapered body portion can define a slit that extends from proximate a bottom surface of the flange to the distal end of the tapered body portion. Still further, the tapered body portion can define a slot that extends from the distal end of the tapered body portion to proximate the bottom surface of the flange and that is sized and shape for receipt of a complementary key member.

FIG. 9 is a cross-sectional view of the bushing of FIG. 8 taken across line 9-9 of FIG. 8, showing a bushing having flange member and an integrally coupled tapered body portion that extends distally therefrom the flange member. The flange member and the inner surface of the tapered body portion defining a bushing bore that is shaped and sized for complementary receipt thereon the distal portion of the driven output shaft. Further, the tapered body portion has an outer surface having a maximum outer diameter proximate the bottom surface of the flange to the distal end of the tapered body portion and that is configured to taper to a minimum outer diameter at the distal end of the tapered body portion. The outer surface of the tapered body portion is formed at a taper angle that allows for complementary engagement with the proximal taper portion of the hub. Also shown, the tapered body portion can define a slot that extends from the distal end of the tapered body portion to proximate the bottom surface of the flange and that is sized and shape for receipt of a complementary key member.

FIG. 10 is a side perspective view of a hub of the power transmission system showing a hub for use within a conventional gear box having an interior hub bore that extends therethrough the hub along a machine axis of the hub. The inner surface of the hub bore defines a slot that extends along a plane that is co-axial to the machine axis of the hub. The outer surface of the proximal end of the hub is shown with a threaded surface for operative threaded engagement with a complementary threaded surface on the inner surface of the central bore. Also shown is an optional bore extending there through the wall of the hub proximate the distal end of the hub. As shown, the exterior surface of the hub has at least one mount surface for mounting of gear(s) associated with the conventional gear train of the conventional gear box.

FIG. 11 is a cross-sectional view of the hub of FIG. 10, showing the interior hub bore that extends therethrough the hub along a machine axis of the hub. As shown, the proximal taper portion of the hub bore of the single-taper hub has an interior wall that is tapered inwardly from the proximal end of the hub until reaching a first uniform diameter portion of the hub bore of the single-taper hub. The interior wall of the proximal portion of the hub bore is formed at a taper angle that allows for complementary engagement with the outer surface of the tapered body portion of the bushing. Also shown is a second uniform diameter portion of the hub bore that extends from the first uniform diameter portion of the hub bore to the distal end of the single taper hub. Further, an optional set-screw bore extending through the wall of the hub proximate the distal end of the hub is shown.

FIGS. 12A-12C show an exemplary embodiment of the installation of a driven output shaft into operative engagement with the hub of a gear box showing a first step in FIG. 12A in which the flange of the bushing is positioned proximate the shoulder surface of the backing plate and the snap-ring spring member is mounted in the slot of the backing plate to constrain the flange of the bushing between the shoulder surface of the backing plate and the snap-ring spring member of the bushing. In a second step shown in FIG. 12B, the coupled bushing and backing member are positioned onto the distal end of the driven output shaft at a desired final position such that the slot of the bushing member that extends from the distal end of the tapered body portion to proximate the bottom surface of the flange is positioned to overlie the elongated keyway defined in the distal portion of the driven output shaft. Subsequently, a key member is positioned through the slot of the bushing member and into the keyway of the driven member such that an upper edge of the key member extends a desired distance therefrom the outer surface of the bushing proximate the keyway. As shown in FIG. 12C (in which the housing of the gear box is not shown for clarity), the bushing, the key member and the distal portion of the driven output shaft can be introduced therein the proximal portion of the hub bore of the single-taper hub such that the key member is aligned with the slot defined in the inner surface of the hub bore. Subsequently, the back plate can be engaged to axially move the back plate relative to the proximal end of the hub and into an engaged position relative to the hub by threading the back plate thereon the threaded outer surface of the proximal end of the hub for operative threaded engagement with the complementary threaded surface on the inner surface of the central bore of the back plate.

FIG. 13 is a perspective view of the completed installation shown in FIGS. 12A-12C, showing a driven output shaft positioned into operative engagement with the hub of a gear box in which the flange of the bushing is positioned proximate the shoulder surface of the backing plate and the snap-ring spring member is mounted in the slot of the backing plate to constrain the flange of the bushing between the shoulder surface of the backing plate and the snap-ring spring member of the bushing.

FIG. 14 is a cross-sectional view of the completed installation of FIG. 13, showing the driven output shaft positioned into operative engagement with the hub of a gear box in the engaged position, in which the flange of the bushing is positioned proximate the shoulder surface of the backing plate and the snap-ring spring member is mounted in the slot of the backing plate to constrain the flange of the bushing between the shoulder surface of the backing plate and the snap-ring spring member of the bushing. Also shown is the key positioned through the slot of the bushing member and into the keyway of the driven member such that an upper edge of the key member extends a desired distance therefrom the outer surface of the bushing proximate the keyway. As further shown in the engaged position in which movement of the bushing and driven output shaft is constrained from further axial movement toward the distal end of the hub, the upper edge portion of the key is positioned within the slot defined in the inner surface of the hub bore such that rotative movement of the hub causes direct and synchronous rotative movement of the operably coupled bushing, backing plate and driven output shaft.

FIG. 15 is an enlarged view of the completed installation of FIG. 14, showing the driven output shaft positioned into operative engagement with the hub of a gear box in the engaged position, in which the flange of the bushing is positioned proximate the shoulder surface of the backing plate and showing the snap-ring spring member being mounted in the slot of the backing plate to constrain the flange of the bushing between the shoulder surface of the backing plate and the snap-ring spring member of the bushing. As further shown in the engaged position in which movement of the bushing and driven output shaft is constrained from further axial movement toward the distal end of the hub, the upper edge portion of the key is positioned within the slot defined in the inner surface of the hub bore such that rotative movement of the hub causes direct and synchronous rotative movement of the operably coupled bushing, backing plate and driven output shaft.

FIG. 16 is a perspective cross-sectional view of the completed installation of FIG. 13, showing the driven output shaft positioned into operative engagement with the hub of a gear box in the engaged position, in which the flange of the bushing is positioned proximate the shoulder surface of the backing plate and the snap-ring spring member is mounted in the slot of the backing plate to constrain the flange of the bushing between the shoulder surface of the backing plate and the snap-ring spring member of the bushing. Also shown is a cap member that is sized to releasably mount to the distal end of the hub such that the interior cavity of the hub bore can be protected from the external environment. As shown, a circumferential wall member of the cap member can include a cap set-screw bore that extends though the wall member. As shown, a mount set-screw can be used to extend in threaded communication into the cap set-screw bore and the set-screw bore that extends through the wall of the hub proximate the distal end of the hub to releasably mount the cap member to the distal end of the hub.

FIGS. 17A-17C show an exemplary embodiment of the installation of a driven output shaft into operative engagement with the hub of a gear box showing a first step in FIG. 17A (where the housing of the gear box is not shown for clarity) in which the backing member is threadedly engaged to the hub to axially move the back plate relative to the proximal end of the hub and into a desired position relative to the hub by threading the back plate thereon the threaded outer surface of the proximal end of the hub for operative threaded engagement with the complementary threaded surface on the inner surface of the central bore of the back plate. In a second step shown in FIG. 17B, the bushing is positioned onto the distal end of the driven output shaft to a desired final position such that the slot of the bushing member that extends from the distal end of the tapered body portion to proximate the bottom surface of the flange is positioned to overlie the elongated keyway defined in the distal portion of the driven output shaft. Subsequently, a key member is positioned through the slot of the bushing member and into the keyway of the driven member such that an upper edge of the key member extends a desired distance therefrom the outer surface of the bushing proximate the keyway. As shown in FIG. 17C, the bushing and the key member are introduced therein the proximal portion of the hub bore of the single-taper hub such that the key is aligned with the slot defined in the inner surface of the hub bore. Subsequently, respective fasteners can be placed though the respective flange bores of the flange of the bushing and into operative threaded communication with respective complementary mount bores in the backing plate such that the flange of the bushing can be engaged to axially move the flange of the bushing distally and toward to the shoulder surface of the backing member that is positioned on the hub until reaching an engaged position relative to the hub.

FIG. 18 is a perspective view of the completed installation shown in FIGS. 17A-17C, showing a driven output shaft positioned into operative engagement with the hub of a gear box in which the flange of the bushing is positioned proximate the shoulder surface of the backing plate and a plurality of fasteners is mounted onto the flange of the bushing and into operative engagement with the underlying backing plate to axially constrain the flange of the bushing relative to the shoulder surface of the backing. As further shown in the engaged position in which movement of the bushing and driven output shaft is constrained from further axial movement toward the distal end of the hub, the upper edge portion of the key is positioned within the slot defined in the inner surface of the hub bore such that rotative movement of the hub causes direct and synchronous rotative movement of the operably coupled bushing, backing plate and driven output shaft.

FIG. 19 is a cross-sectional view of the completed installation of FIG. 18, showing the driven output shaft positioned into operative engagement with the hub of a gear box in the engaged position, in which the flange of the bushing is positioned proximate the shoulder surface of the backing plate and showing a fastener mounted in threaded engagement with a mount bore of the backing plate to constrain the flange of the bushing from axial movement away from the shoulder surface of the backing plate when the bushing and the driven output shaft are in the engaged position in which the bushing and the driven output shaft are constrained from further axial movement toward the distal end of the hub via operative engagement of the outer surface of the tapered body portion of the bushing and the complementary surface of the interior wall of the proximal taper portion of the hub.

FIG. 20 is an enlarged view of the completed installation of FIG. 18, showing the driven output shaft positioned into operative engagement with the hub of a gear box in the engaged position, in which the flange of the bushing is positioned proximate the shoulder surface of the backing plate and showing a fastener mounted in threaded engagement with a mount bore of the backing plate to constrain the flange of the bushing from axial movement away from the shoulder surface of the backing plate when the bushing and the driven output shaft are in the engaged position. As further shown in the engaged position in which movement of the bushing and driven output shaft is constrained from further axial movement toward the distal end of the hub, the upper edge portion of the key is positioned within the slot defined in the inner surface of the hub bore such that rotative movement of the hub causes direct and synchronous rotative movement of the operably coupled bushing, backing plate and driven output shaft.

FIG. 21 is a perspective cross-sectional view of the completed installation of FIG. 18, showing the driven output shaft positioned into operative engagement with the hub of a gear box in the engaged position, in which the flange of the bushing is positioned proximate the shoulder surface of the backing plate and showing a fastener mounted in threaded engagement with a mount bore of the backing plate to constrain the flange of the bushing from axial movement away from the shoulder surface of the backing plate when the bushing and the driven output shaft are in the engaged position. Also shown is a cap member that is sized to releasably mount to the distal end of the hub such that the interior cavity of the hub bore can be protected from the external environment.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a fastener” can include two or more such fasteners unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It should be appreciated, that as used herein, terms of approximation, such as a “about” or “approximately,” refers to being within 10% margin of error.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish claim elements.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems can be understood more readily by reference to the following detailed description of preferred embodiments and the examples included therein and to the Figures and their previous and following description.

The invention provides a novel technique for assembling hubs and shafts in mechanical power transmission systems designed to respond to these needs. The technique employs a single-taper hub or quill approach to the mechanical support of the operably coupled hub 20, bushing 40, and backing plate 60. In operation, the power transmission system 10 described herein can form a low-profile structure which can facilitate reduction of overhung loads in the power transmission arrangement.

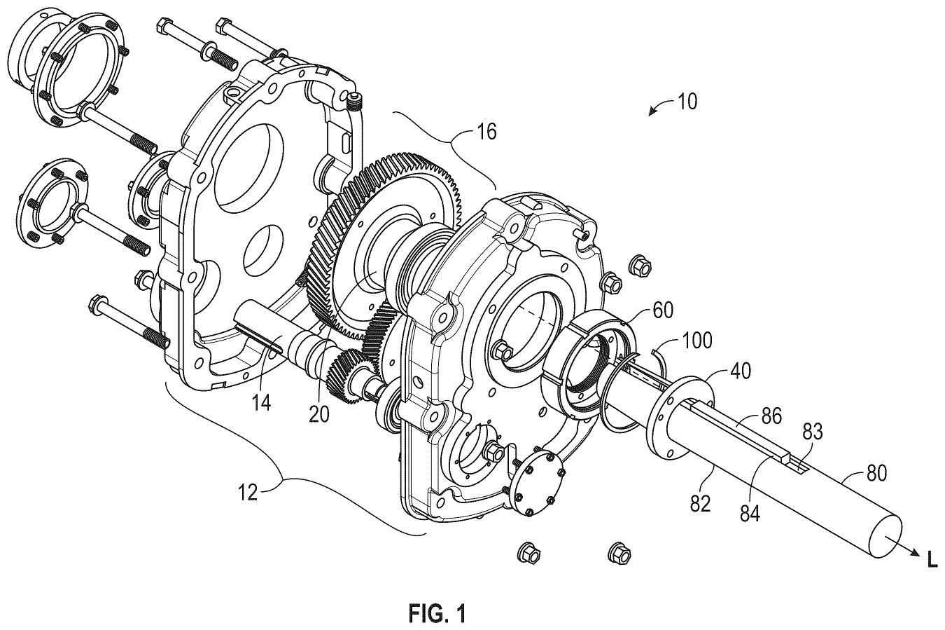

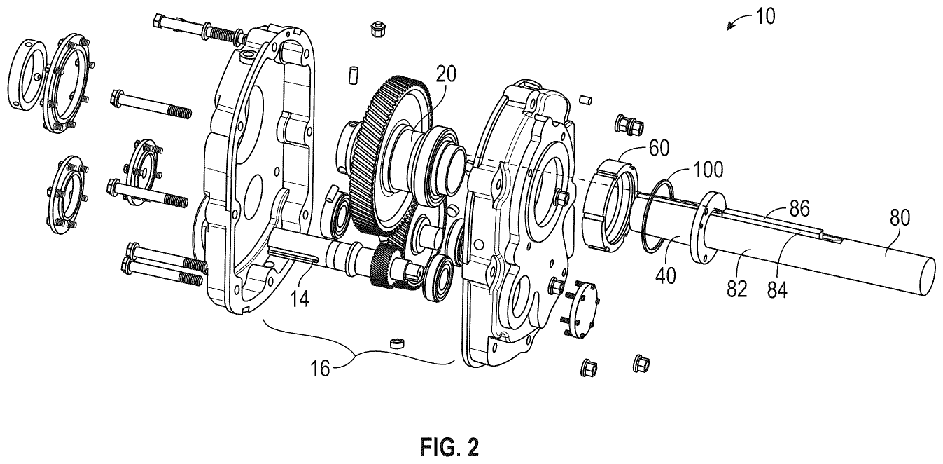

Referring to FIGS. 1 and 2, which schematically illustrate an exploded example of a power transmission system 10 showing a gear box 12 having an input shaft 14 and a gear train 16 in geared communication with the input shaft and a single-tapered hub 20. In this exemplary power transmission system 10, a driven output shaft 80 can be operably and rotatably coupled to the single-tapered hub 20 such that rotation of the single-tapered hub 20 can result in direct and complementary rotation of the driven output shaft 80.

In embodiments, and as described in greater detail below, a bushing 40 can be mounted there around a distal portion 82 of the driven output shaft 80. In this aspect, the bushing 40 can have a flange member 42 positioned at the proximal end of the bushing that is configured to be operably received within a shoulder mount 63 of a backing plate 60, which is also configured to be receive the distal portion 82 of the driven output shaft 80. In embodiments, and as described in greater detail below, the backing plate 60 is configured for selective mounting to a threaded surface of an exterior surface 34 of the proximal end portion of the hub 20.

In embodiments, and as illustrated, an elongated keyway 84 can be defined in a distal portion 82 of the driven output shaft 80 and a key member 86 that is configured to be received therein the keyway through a slot in a tapered body portion of the bushing 40 such that an upper edge 87 of the key member 86 extends a desired distance therefrom the outer surface of the bushing 40 proximate the keyway 84 when the bushing is positioned to overlie the distal portion 82 of the driven output shaft 80 that has the defined keyway 84. In this aspect, it is contemplated that the elongated keyway 84 extends parallel to a longitudinal axis of the driven output shaft 80 from the distal end of the driven output shaft 80 to a second stop 83 that is spaced from the distal end of the driven output shaft 80.

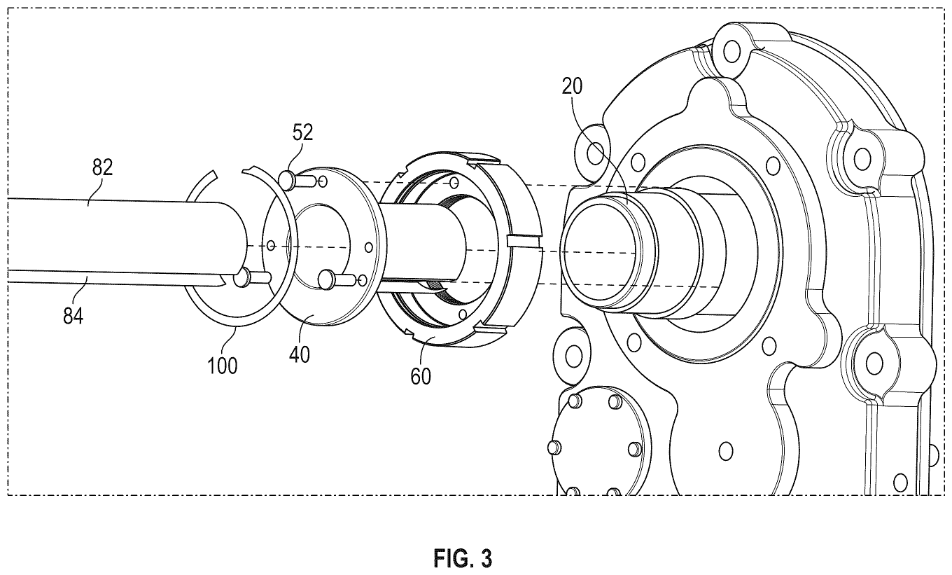

Referring to FIG. 3, and as described in more detail below, the disclosed power transmission system 10 provides alternative methodologies for selectively coupling or fixing the bushing 40 relative to the backing plate 60 when the bushing and driven output shaft 80 are placed into complementary engagement with the hub 20 of the gear box in an engaged position. In the engaged position, one skilled in the art will appreciate that the constrained position of the bushing 40 relative to the backing plate 60 and the frictional engagement of the exterior surface of a portion of the distal portion 82 of the driven output shaft 80 thereto the inner surface 46 of the tapered body portion 44 of the bushing acts to axially constrain movement of the operable coupled driven output shaft 80, bushing 40, and backing plate 60 relative to the hub 20 while allowing for direct and synchronous rotation of the driven output shaft 80 in response to rotation of the hub 20 of the gear box 12.

As described in more detail below, the respective means for axially constraining movement of the operable coupled driven output shaft 80, bushing 40, and backing plate 60 relative to the hub 20 can include the use of a snap-ring spring member 100 that is configured to be received within a backing plate slot 73 defined within the backing plate 60 and/or can optionally include the use of a plurality of mount fasteners 52 that are configured to position a flange member 42 of the bushing 40 at a desired distance from a shoulder surface 64 of the backing plate 60.

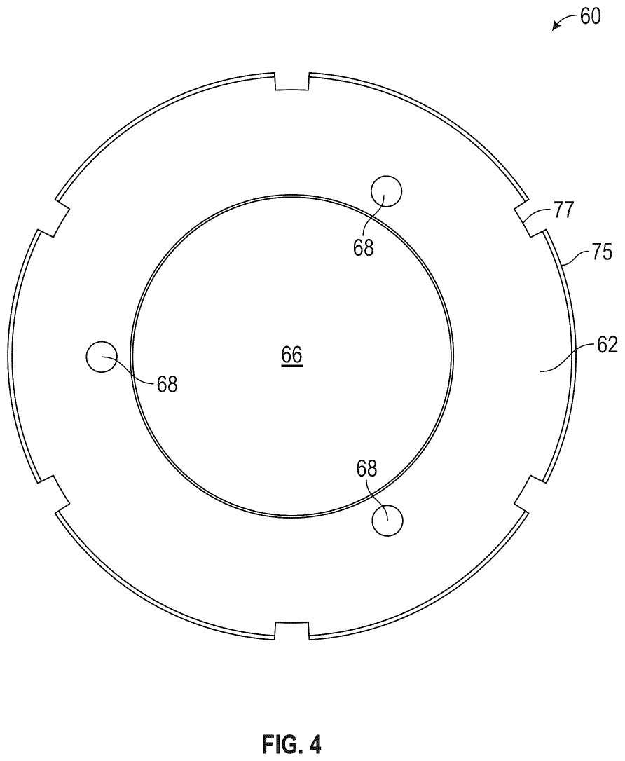

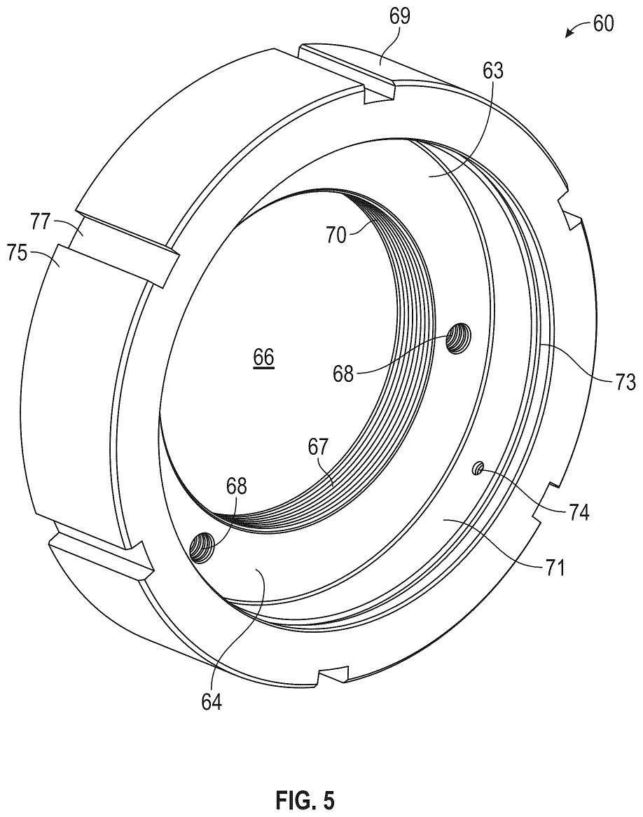

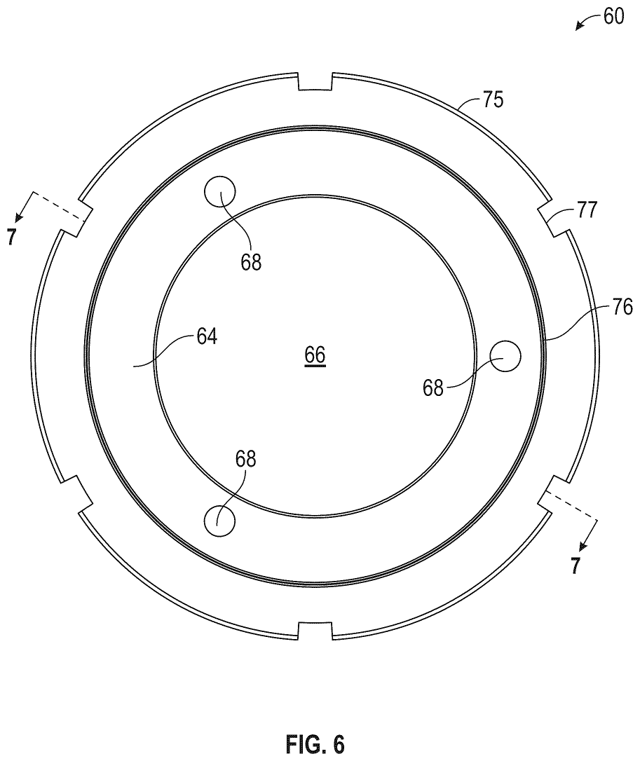

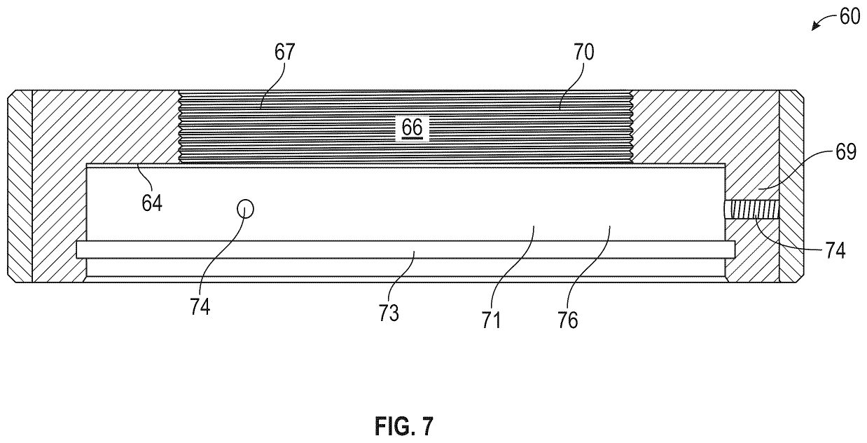

Referring to FIGS. 4-7, the backing plate 60 is shown in which the backing plate has a ring shape that has an upper surface 62 and an opposed shoulder surface 64. The backing plate 60 defines a central bore 66 that extends through the backing plate 60 and has a diameter that allows for the backing plate to be slideably received thereon the distal portion 82 of the driven output shaft 80. In this aspect, the backing plate 60 can further define a plurality of mount bores 68 that are spaced about and from the central bore, which mount bores extend through the backing plate to open thereon the shoulder surface 64 and are each configured for threaded receipt of a complementary mount fastener 52, such as, for example, a bolt.

In a further aspect, and as shown in FIG. 5, an inner surface 67 of the central bore of the backing plate 60 forms a threaded surface 70 that is configured for operative threaded engagement with a complementary threaded surface 34 on the exterior surface 32 of the proximal end portion of the hub 20. In aspects, it is contemplated that the respective complementary threaded surfaces formed on the inner surface of the central bore and the exterior surface of the proximal end of the hub can have a thread pitch having a threads-per-inch (TPI) that is between about 3 to about 20, preferably between about 4 to about 18, and more preferred, between about 6 to about 16. Optionally, the respective complementary threaded surfaces formed on the inner surface of the central bore and the exterior surface of the proximal end of the hub can have a thread pitch that is less than 16 TPI.

As further shown, the backing plate 60 has a wall member 69 that is integrally connected to an edge of the backing plate and extends distally to a distal edge such that the backing plate 60 is generally cup shaped in cross-section with the shoulder surface 64 and the wall member 69 forming the shoulder mount 63.

The wall member 69 further defining a second bore 76 that is positioned co-axially relative to the axis of the central bore 66 and that has a diameter that is greater than the diameter of the central bore. Further, the inner surface 71 of the wall member 69 can define the backing plate slot 73 proximate the distal edge of the backing plate that extends circumferentially in a plane that is positioned transverse to the axis of the central bore of the backing plate and which is configured for receipt of a snap-ring spring member 100. In embodiments, the backing plate slot 73 can be spaced from the shoulder surface 64 of the backing plate at a desired distance that is at least the width of the flange member 42 of the bushing 40.

As one will appreciate and as shown in the figures, it is contemplated that the operative inner diameter of the snap-ring spring member 100 when seated in the slot 73 of the backing plate is less than the outer diameter of the flange member 42 of the bushing 40, which thereby allows the seated snap-ring spring member to act to constrain axial movement of the flange member 42 relative proximal end of the backing plate and relative to the longitudinal axis of the hub 20. Further, the exterior surface 75 of the wall member 69 can define one or more fastener features 77 that are adapted for receipt of a conventional fastener tool.

In an optional aspect, the wall member 69 can further define a threaded set-screw bore 74 that extends from an outer surface of the wall member to an inner surface of the wall member. As one skilled in the art will appreciate, the set-screw bore 74 can be configured for operative receipt of a complementarily threaded set-screw.

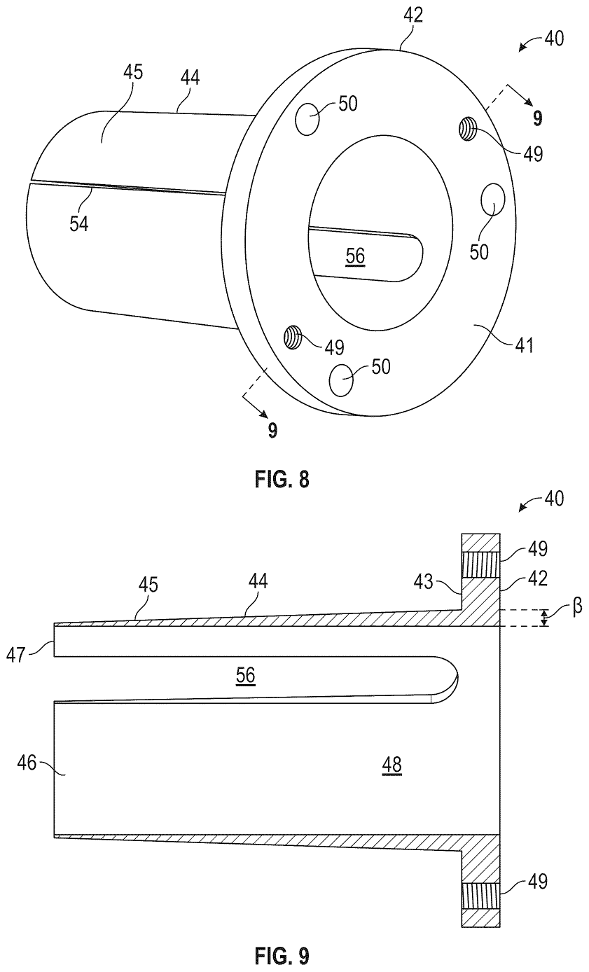

Referring to FIGS. 8 and 9, the bushing 40 of the power transmission system 10 includes a flange member 42 and an integrally coupled tapered body portion 44 that extends distally therefrom the flange member. In aspects, the flange member 42 and the inner surface 46 of the tapered body portion 44 defines a bushing bore 48 that is shaped and sized for complementary receipt thereon the exterior surface of the distal portion 82 of the driven output shaft 80. It is contemplated that, when in the engaged position, portions of the inner surface 46 of the tapered body portion 44 of the bushing 40 can frictionally engage underlying portions of the exterior surface of the distal portion 82 of the driven output shaft.

In this embodiment, it is contemplated that the tapered body portion 44 of the bushing has an outer surface 45 having a maximum outer diameter proximate the bottom or distally facing surface 43 of the flange member 42 that is configured to taper to a minimum outer diameter at a distal end 47 of the tapered body portion 44. As shown, the outer surface 45 of the tapered body portion 44 is formed at an acute taper angle β with respect to the longitudinal axis of the bushing 40, which allows for complementary engagement with the wall 25 forming the proximal taper portion 23 of the hub bore 21.

The flange member 42 can further define a plurality of flange bores 50 that are each shaped and sized for complementary receipt of mounting fasteners 52 that are configured to mount thereto the mount bores 68 of the backing plate 60.

In an optional embodiment, the flange member 42 can further define at least one threaded aperture 49 that extends from an upper surface 41 of the flange member to a bottom surface 43 of the flange member. In this aspect, the at least one threaded aperture 49 can comprise a plurality of apertures 49 spaced about the flange member 42. In embodiments and as exemplarily illustrated, the plurality of apertures 49 can include a pair of spaced apertures that are positioned along a common axis that bisects a longitudinal axis of the bushing bore 48. As one skilled in the art will appreciate, each threaded aperture 49 can be configured for operative receipt of a complementarily threaded fastener, such as a conventional screw, bolt, and the like [not shown]. It is also contemplated that, when in the engaged position, the at least one aperture 49 aperture overlies the shoulder surface of the backing plate.

Also shown, the tapered body portion 44 can optionally define a slit 54 that extends from proximate the bottom surface 43 of the flange member 42 to the distal end 47 of the tapered body portion to allow for an operative reduction in diameter of the bushing bore as the bushing is urged into the engaged position. Still further, it is contemplated that the tapered body portion 44 of the bushing 40 can define a bushing slot 56 that extends from the distal end 45 of the tapered body portion to proximate the bottom surface 43 of the flange member 42 that is sized and shape for receipt of a complementary key member 86.

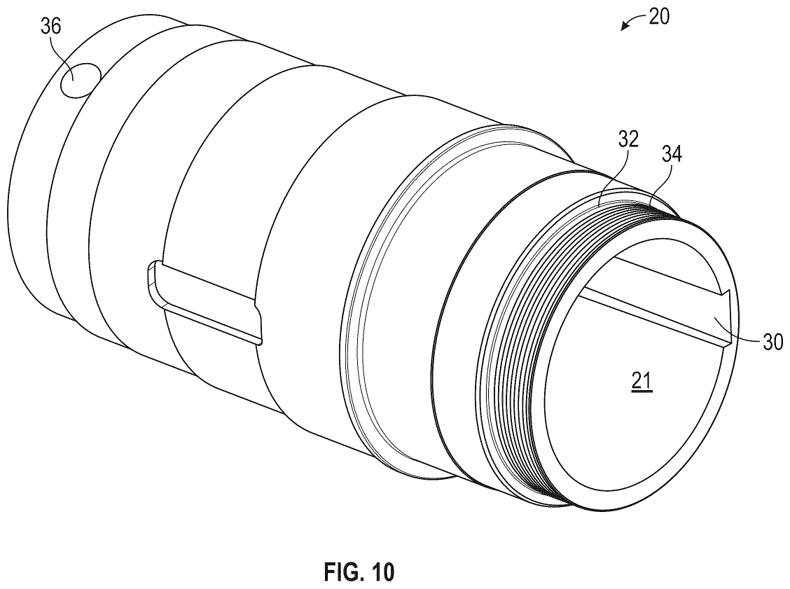

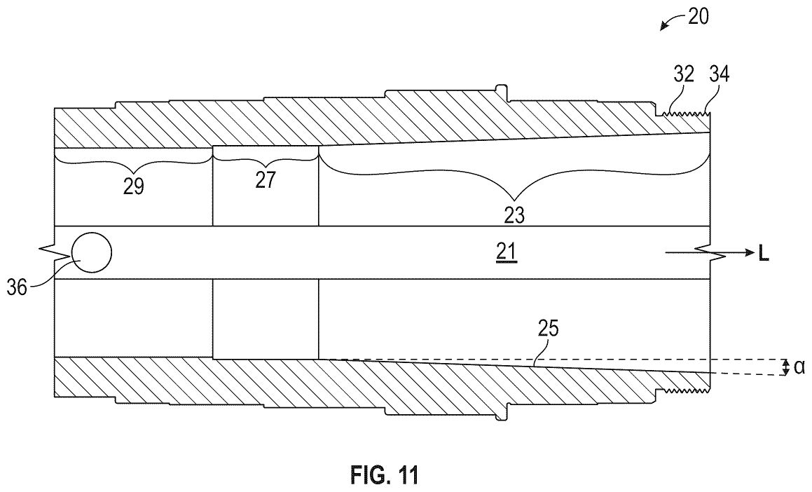

Referring to FIGS. 10 and 11, a hub 20 for use within a conventional gear box 12 is shown defining an interior hub bore 21 that extends therethrough the hub from a proximal end to a distal end along a machine or longitudinal axis of the hub. As shown, a proximal taper portion 23 of the hub bore 21 of the hub 20 has an interior wall 25 that is tapered inwardly from the proximal end of the hub until reaching a first uniform diameter portion 27 of the hub bore of the hub. The interior wall 25 of the proximal taper portion 23 of the hub bore is formed at an acute taper angle α relative to the machine or longitudinal axis of the hub 20. In operation, it is contemplated that the acute taper angle β formed by the outer surface 45 of the tapered body portion of the bushing 40 can be substantially the same as the acute taper angle α of the interior wall 25 of the proximal taper portion 23 of the hub bore, which allows for complementary engagement of the interior wall 25 of the proximal taper portion 23 of the hub bore with the outer surface 45 of the tapered body portion 44 of the bushing 40.

In another aspect, a second uniform diameter portion 29 of the hub bore 21 can extend from the first uniform diameter portion 27 of the hub bore to the distal end of the hub. In this aspect, it is contemplated to minimize the space tolerance between the diameter of the second uniform diameter portion 29 relative to the diameter of the driven output shaft 80 that would be operably positioned within the second uniform diameter portion of the hub bore when the backing plate 60, the bushing 40, and the driven output shaft 80 are positioned in the engaged position.

In embodiments, it is contemplated to minimize the space tolerance to allow for the operable constraint of the distal end of the driven output shaft 80 under load. In aspects, the space tolerance can be between about 0.0015″ to about 0.0075″ between the respective opposing surfaces formed by outer surface of the driven output shaft and the surface of the second uniform diameter portion. In further aspects, the space tolerance can preferably be between about 0.0020″ to about 0.005″, and more preferably the space tolerance can be about 0.0025″.

In embodiments, the hub bore defines a hub slot 30 in the inner surface of the bore that extends along a plane that is co-axial to the machine axis of the hub. In this aspect, and as shown in the figures, the hub slot 30 can be sized and shape for receipt of the upper edge portion the complementary key member 86.

As further contemplated, an exterior surface 32 of the proximal end of the hub 20 can include a threaded surface 34 that provides for operative threaded engagement with a complementary threaded surface on the inner surface 67 of the central bore 66 of the backing plate 60.

In an optional aspect, a cap set-screw bore 36 can be provided that extends through the wall of the hub proximate the distal end of the hub for the mounting of a cap member 38. In a further aspect, and as exemplarily shown in the figures without limitation, the exterior surface of the hub 20 can include at least one mount surface that is configured for mounting of gear(s) associated with a conventional gear train of the gear box 12.

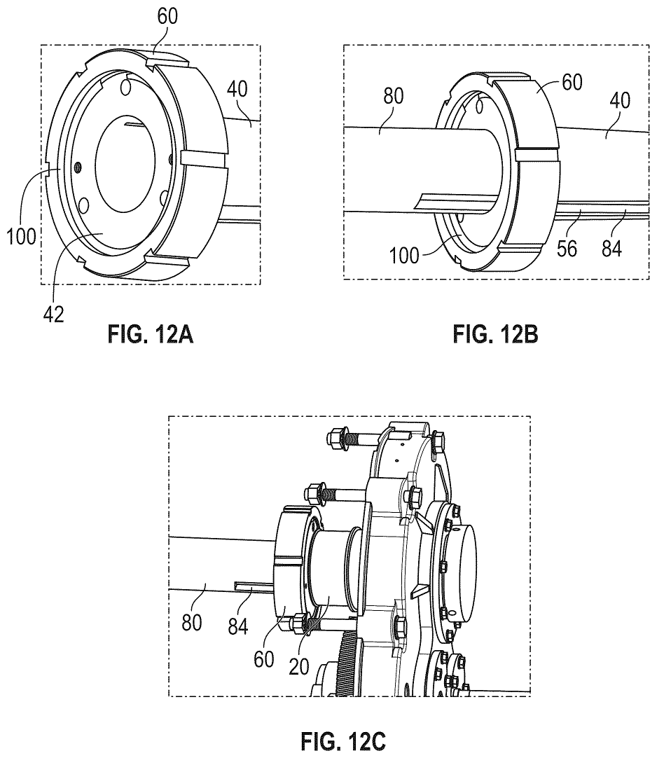

FIGS. 12A-12C show an exemplary embodiment of the installation of a driven output shaft 80 into operative engagement with the hub 20 of a gear box 12. In a first step shown in FIG. 12A, the flange member 42 of the bushing 40 can be positioned proximate the shoulder surface of the backing plate 60 and the snap-ring spring member 100 can be subsequently mounted in the slot 73 of the backing plate 60 to constrain the flange member 42 of the bushing between the shoulder surface of the backing plate and the snap-ring spring member 100 of the bushing.

In a second step shown in FIG. 12B, the coupled bushing 40 and backing plate 60 can be positioned onto the distal end of the driven output shaft 80 at a desired final position such that the bushing slot 56 of the bushing 40 that extends from the distal end of the tapered body portion 44 to proximate the bottom surface of the flange member 42 is positioned to overlie the elongated keyway 84 defined in the distal portion 82 of the driven output shaft 80. Subsequently, a key member 86 can be positioned through the bushing slot 56 of the bushing 40 and into the keyway 84 of the driven member such that the upper edge 87 of the key member 86 extends a desired distance therefrom the outer surface of the bushing 40 proximate the keyway 84.

Next, in a third step shown in FIG. 12C (in which a portion of the housing of the gear box is not shown for clarity), the bushing 40, the key member 86 and the distal portion 82 of the driven output shaft 80 can be introduced therein the proximal taper portion 23 of the hub bore 21 such that the key member 86 is aligned for complementary introduction with the hub slot 30 defined in the inner surface of the hub bore 21. Subsequently, the backing plate can be engaged to axially move the backing plate 60 relative to the proximal end of the hub 20 and into an engaged position relative to the hub by threading the backing plate 60 thereon the threaded surface 34 of the proximal end of the hub 20 for operative threaded engagement with the complementary threaded surface on the inner surface 67 of the central bore 66 of the backing plate 60.

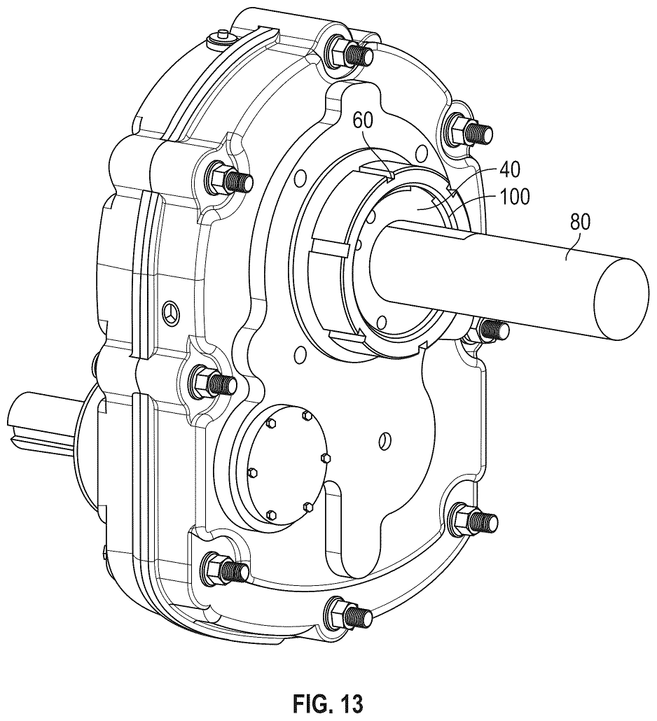

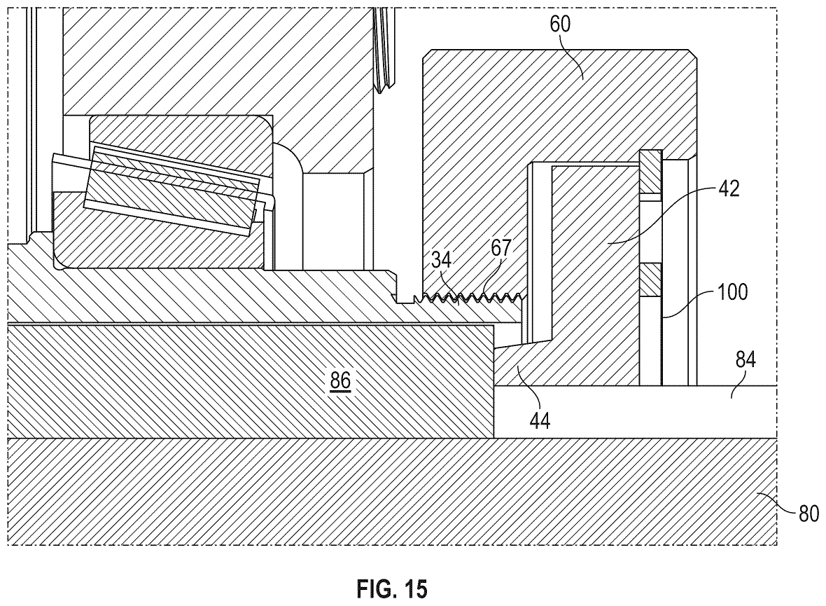

Referring to FIGS. 13-16, it is contemplated that when the driven output shaft 80 is positioned into operative engagement with the hub of a gear box in the engaged position, the flange member 42 of the bushing 40 will be positioned proximate the shoulder surface of the backing plate and therebetween the shoulder surface of the backing plate and the snap-ring spring member 100 mounted in the slot of the backing plate to constrain the flange member 42 of the bushing between the shoulder surface of the backing plate and the snap-ring spring member 100 of the bushing and to constrain the axial movement of the flange member 42 of the bushing 40 relative to the backing plate 60.

To separate the backing plate and the coupled bushing from the proximal end of the hub, the backing plate can be engaged to axially move the backing plate 60 proximally away from the proximal end of the hub 20 and away from the engaged position relative to the hub to separate the backing plate and the coupled bushing from the hub. Optionally, if the set screw is engaged to the backing plate, the set screw can be backed away from contact prior to attempting to engage the backing plate.

Optionally, if the backing plate 60 resists rotation, the snap-ring spring member 100 can be removed from the bushing slot to remove an axial constraint barrier that could act on the flange member of the bushing. Subsequently, the flange member of the bushing can be urged proximally relative to the shoulder surface of the backing plate to remove the bushing and the driven output shaft from operative contact with the hub.

In a further optional aspect that can be used if the flange member of the bushing resists moving proximally relative to the shoulder surface of the backing plate after the snap-ring spring member 100 is removed, the operator can threadedly insert at least one complementarily threaded fastener therein the respective at least one threaded aperture 49 of the flange member. As one will appreciate, a distal end of each complementarily threaded fastener can apply compressive force thereon the underlying shoulder surface of the backing plate when the complementarily threaded fastener is threadedly moved distally relative to the bottom surface of the flange member. One will appreciate that the resulting compressive force applied by the complementarily threaded fastener will allow for proximal movement of the flange member of the bushing relative to the backing plate such that the bushing can subsequently be urged proximally relative to the shoulder surface of the backing plate to remove the bushing and the driven output shaft from operative contact with the hub.

In the engaged position, it is contemplated that the key member 86 positioned through the bushing slot 56 of the bushing 40 and into the keyway 84 of the driven member such that an upper edge portion 87 of the key member 86 extends a desired distance therefrom the outer surface of the bushing proximate the keyway 84 and into engagement with the hub slot defined in the inner surface of the hub bore. Thus, in the engaged position, it is contemplated that movement of the bushing 40 and the engaged driven output shaft 80 is constrained from axial movement toward the distal end of the hub. Further, as a result of the upper edge portion of the key member 86 being operably positioned within the hub slot 30 defined in the inner surface of the hub bore 21, rotative movement of the hub 20 causes direct and synchronous rotative movement of the operably coupled bushing 40, backing plate, and driven output shaft 80.

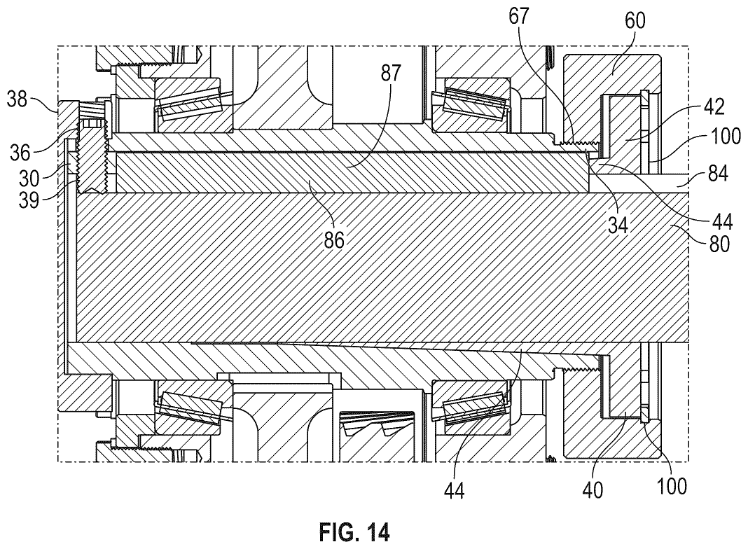

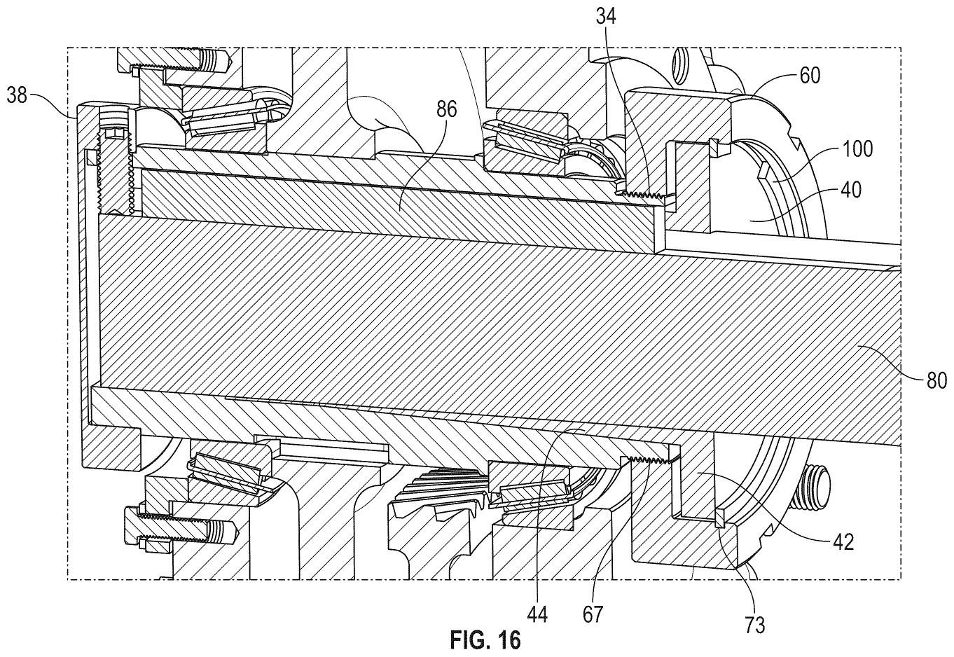

Optionally, a cap member 38 can be provided that is sized and shaped to releasably mount to the distal end of the hub 20 such that the interior cavity of the hub bore 21 can be protected from the external environment. Referring to FIGS. 14 and 16, a circumferential wall member of the cap member can include a cap set-screw bore 36 that extends though the wall member. In this aspect, a cap set-screw 39 can be used to extend in threaded communication into the cap set-screw bore 36 and the set-screw bore that extends through the wall of the hub proximate the distal end of the hub to releasably mount the cap member to the distal end of the hub 20.

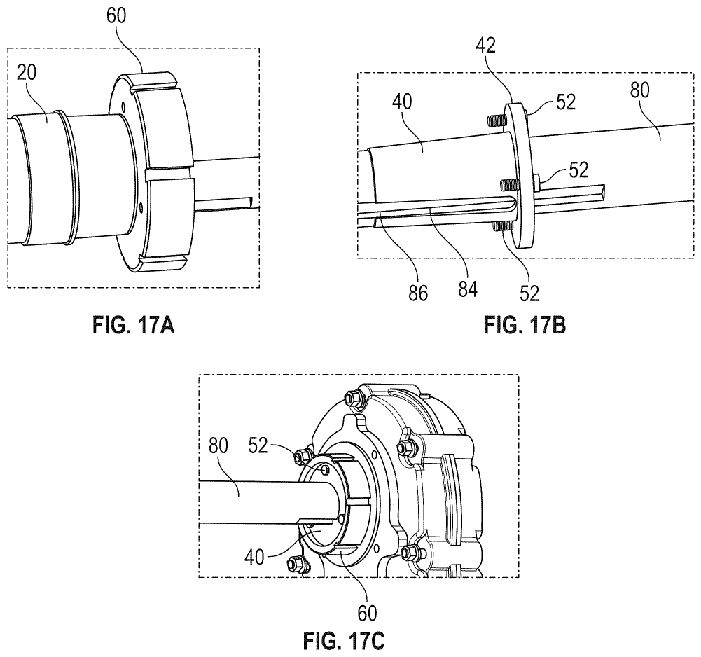

FIGS. 17A-17C show an exemplary embodiment of the installation of a driven output shaft 80 into operative engagement with the hub 20 of a gear box 12. In a first step shown in FIG. 17A (in which the housing of the gear box is not shown for clarity), the backing plate 60 is threadedly engaged to the hub to axially move the backing plate relative to the proximal end of the hub 20 and into a desired position relative to the hub by threading the backing plate thereon the threaded surface 34 of the proximal end of the hub 20 for operative threaded engagement with the complementary threaded surface on the inner surface 67 of the central bore 66 of the backing plate 60.

In a second step shown in FIG. 17B, the bushing 40 is positioned onto the distal end of the driven output shaft 80 at a desired final position such that the bushing slot of the bushing 40 that extends from the distal end of the tapered body portion to proximate the bottom surface of the flange member 42 is positioned to overlie the elongated keyway 84 defined in the distal portion 82 of the driven output shaft 80. Subsequently, a key member 86 can be positioned through the bushing slot of the bushing 40 and into the keyway of the driven member such that an upper edge 87 of the key member 86 extends a desired distance therefrom the outer surface of the bushing 40 proximate the keyway 84.

Subsequently, and as shown in FIG. 17C, the bushing 40 and the key member 86 are introduced therein the proximal taper portion 23 of the hub bore 21 of the hub such that the key member is operably aligned with the hub slot 30 defined in the inner surface of the hub bore 21. Next, respective mount fasteners 52 can be placed though the respective flange bores 50 of the flange member 42 of the bushing 40 and into operative threaded communication with respective complementary mount bores 68 in the backing plate 60 such that the flange member 42 of the bushing 40 can be engaged to axially move the flange member of the bushing distally and toward to the shoulder surface of the backing member that is positioned in the desired position on the hub until reaching an desired position relative to the hub.

In embodiments, to separate the bushing from the backing plate, respective mount fasteners 52 are engaged to remove the mount fasteners from operative threaded communication with the respective complementary mount bores 68 in the backing plate 60. Upon removal of the mount fasteners, the flange member 42 of the bushing 40 can be engaged to axially move the flange member of the bushing proximally and away from the shoulder surface of the backing member that is positioned in the desired position on the hub until the bushing and the driven output shaft are separated from the hub. Optionally, if a set screw in the flange member is engaged to the hub, the set screw can be backed away from contact prior to attempting to engage the flange member.

In a further optional aspect that can be used if the flange member of the bushing resists moving proximally relative to the shoulder surface of the backing plate after the mount fasteners are removed, the operator can threadedly insert the complementarily threaded fastener in the respective at least on threaded aperture 49 of the flange member. As one will appreciate, the distal end of each complementarily threaded fastener can apply compressive force thereon the underlying shoulder surface of the backing plate when the complementarily threaded fastener is threadedly moved distally relative to the bottom surface of the flange member. One will appreciate that the resulting compressive force applied by the complementarily threaded fastener will allow for proximal movement of the flange member of the bushing relative to the backing plate such that the bushing can subsequently be urged proximally relative to the shoulder surface of the backing plate to allow for the removal of the bushing and the driven output shaft from operative contact with the hub.

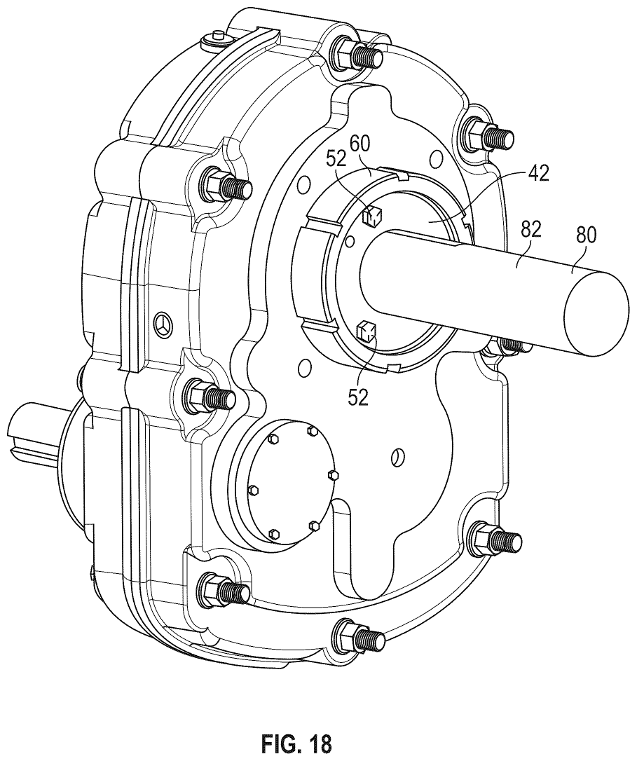

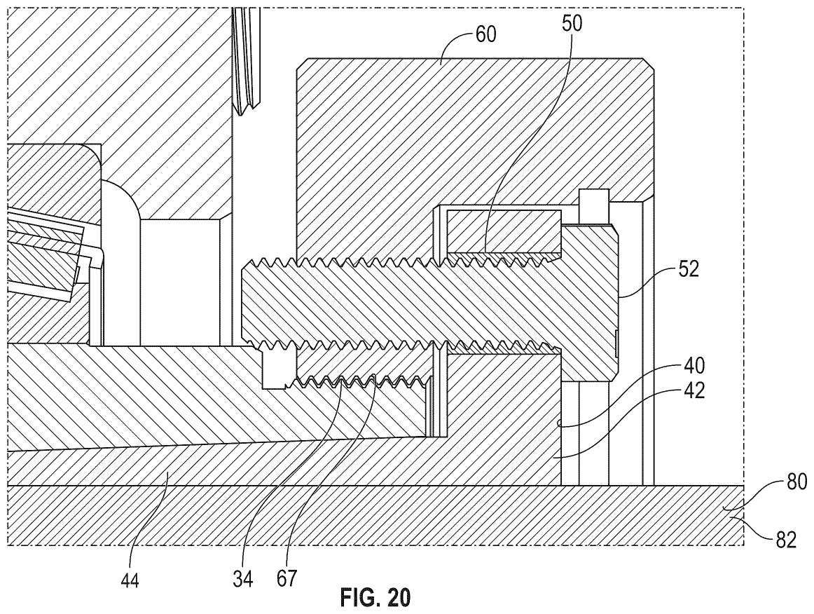

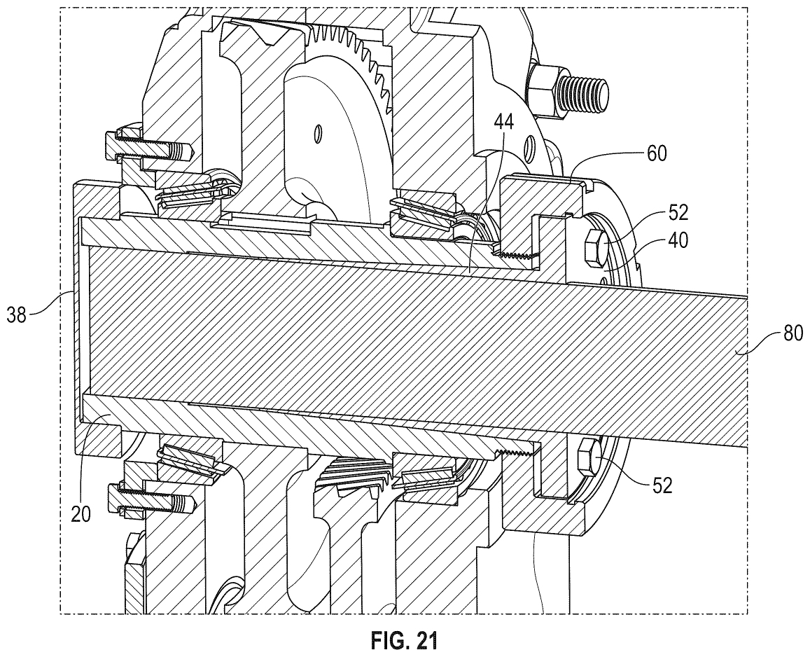

Referring to FIGS. 18-21, it is contemplated that when the driven output shaft 80 is positioned into operative engagement with the hub of a gear box in the engaged position, the flange member 42 of the bushing 40 is positioned proximate the shoulder surface of the backing plate 60 in the desired position and the plurality of fasteners 52 are mounted onto the flange member 42 of the bushing 40 and into operative engagement with the underlying backing plate 60 to axially constrain the flange member of the bushing relative to the shoulder surface of the backing plate 60. As further shown, it is contemplated that in the engaged position, in which movement of the bushing and engaged driven output shaft 80 is constrained from further axial movement toward the distal end of the hub, the upper edge 87 portion of the key member 86 is positioned within the hub slot defined in the inner surface of the hub bore such that rotative movement of the hub 20 causes direct and synchronous rotative movement of the operably coupled bushing 40, backing plate 60 and the engaged driven output shaft 80.

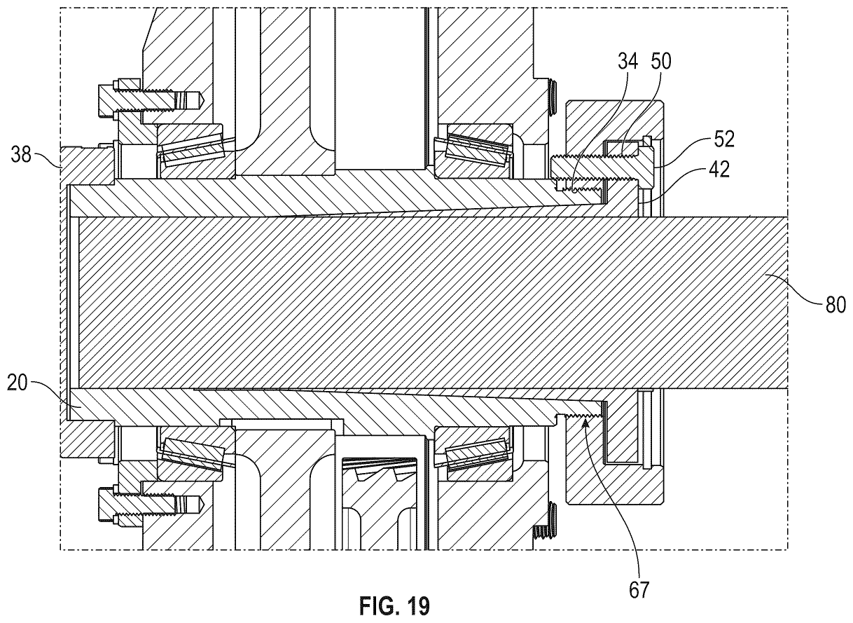

As shown in FIG. 19, when the bushing 40 and the driven output shaft 80 are in the engaged position, the flange member 42 of the bushing is positioned proximate the shoulder surface of the backing plate 60 and the respective fasteners that are mounted in threaded engagement with the respective mount bores of the backing plate can act to constrain the flange member 42 of the bushing from axial movement away from the shoulder surface of the backing plate. Further, it is contemplated that when the bushing 40 and the driven output shaft 80 are in the engaged position, the bushing 40 and the driven output shaft 80 are constrained from further axial movement toward the distal end of the hub via operative engagement of the outer surface of the tapered body portion of the bushing 40 and the complementary surface of the interior wall of the proximal taper portion of the hub.

In various aspects, it should be noted, however, that the specific machinery, components, and configurations described herein with respect to a conventional gear box are in no way limited to any particular system type or application but can be applied to any suitable system in which the mounting and removal techniques described herein can be usefully employed.

Several advantages have been found in the foregoing structure. Firstly, the structure facilitates the connection of the driven output shaft to a hub of a gear box while reducing the number of separate elements which must be aligned and engaged for support. Secondly, the ease of the installation and connection of the drive shaft to the hub of the gear box and the removal of the drive shaft from the hub is markedly improved via use of the system and methods described herein. Thirdly, the system and methods described herein advantageously provide an operator with alternative ways to readily install and separate the bushing and driven output shaft from the respective backing plate and/or hub.

In embodiments, the present disclosure contemplates a power transmission system that is in communication with a driven output shaft that has a distal portion defining an elongated keyway configured to receive a key member and is in geared communication with a gearbox that has an input shaft and a gear train in geared communication with the input shaft. In embodiments, the power transmission system can include a hub, a backing plate, a bushing, and a means for constraining movement of the bushing relative to the backing plate in an engaged position.

In embodiments, the hub can be configured for geared communication with the gear train of the gearbox. In one aspect, the hub can define a hub bore that extends therethrough the hub from a proximal end to a distal end along a longitudinal axis of the hub. As shown, the hub bore has a proximal taper portion forming an interior wall that is tapered inwardly from the proximal end of the hub until reaching a first uniform diameter portion of the hub bore. As further shown, an exterior surface of the proximal end of the hub can include a threaded surface. The hub can further define a hub slot in the inner surface of the bore.

In embodiments, the backing plate can have a shoulder surface and a wall member that is integrally connected to an edge of the backing plate and that extends distally to a distal edge such that the backing plate has a general cup shape in cross-section. A shown, the backing plate defines a central bore that extends through the backing plate. Operatively, an inner surface of the central bore is configured to form a threaded surface that is sized and shaped for selective operative threaded engagement with the complementary threaded surface on the exterior surface of the proximal end of the hub. In embodiments, it is contemplated that the respective complementary threaded surfaces formed on the inner surface of the central bore and the exterior surface of the proximal end of the hub can have a thread pitch having a threads-per-inch (TPI) that is between about 6 to about 16.

In embodiments, the bushing can have a flange member and an integrally coupled tapered body portion that extends distally therefrom the flange member. As shown, the flange member and the inner surface of the tapered body portion define a bushing bore that is shaped and sized for complementary receipt thereon the exterior surface of the distal portion of the driven output shaft. It is contemplated that the tapered body portion of the bushing has an outer surface that is formed to allow for complementary engagement of the interior wall of the proximal taper portion of the hub bore when the outer surface of the tapered body portion of the bushing in an engaged position.

In the engaged position, it is contemplated that portions of the inner surface of the tapered body portion of the bushing can be configured to frictionally engage underlying portions of the exterior surface of the distal portion of the driven output shaft.

In embodiments, in the engaged position, an upper edge portion of the key member extends from the keyway of the driven output shaft through the bushing slot and into engagement with the hub slot such that rotative movement of the hub causes direct and synchronous rotative movement of the operably coupled bushing, backing plate, and driven output shaft. In embodiments, the elongated keyway can extend parallel to a longitudinal axis of the driven output shaft from the distal end of the driven output shaft to a second stop that is spaced from the distal end of the driven output shaft.

In embodiments, it is contemplated that the interior wall of the proximal taper portion of the hub can be formed at an acute taper angle α relative to the longitudinal axis of the hub. Similarly, it is contemplated that the outer surface of the tapered body portion of the bushing can be formed at an acute taper angle β with respect to the longitudinal axis of the bushing. In embodiments, it is contemplated that the acute taper angle β of the outer surface of the tapered body portion of the bushing can be substantially the same as the acute taper angle α of the interior wall of the proximal taper portion of the hub bore.

In further embodiments, it is contemplated that the tapered body portion of the bushing can define a slit extending from proximate the bottom surface of the flange member to the distal end of the tapered body portion to allow for an operative reduction in diameter of the bushing bore as the bushing is urged into the engaged position. In embodiments, and as shown, the flange member of the bushing can further define at least one threaded aperture that extends therethrough the flange member. It is further contemplated that, when the bushing is positioned in the engaged position, the at least one aperture can overlie a portion of the shoulder surface of the backing plate.

In embodiments, it is contemplated that the hub bore can have second uniform diameter portion that extends from the first uniform diameter portion to the distal end of the hub. In this aspect, it is contemplated that the diameter of the second uniform diameter portion can exceed the diameter of the distal portion of the driven output shaft by a space tolerance of between about 0.0015″ to about 0.0075″.

As shown, it is contemplated that the hub slot extends along a plane that is co-axial to the longitudinal axis of the hub, which is sized and shaped for receipt of the upper edge portion the key member.

In embodiments, it is contemplated that the central bore of the backing plate can have a diameter allowing the backing plate to be slideably received thereon the distal portion of the driven output shaft. As shown, the outer surface of the tapered body portion of the bushing has a maximum outer diameter proximate a distally facing surface of the flange member that is configured to taper to a minimum outer diameter at a distal end of the tapered body portion. As further shown, the tapered body portion of the bushing defines a bushing slot that extends from the distal end of the tapered body portion to proximate the flange member, the bushing member being sized and shape for receipt of the key member.

In embodiments, the means for constraining movement of the bushing relative to the backing plate in an engaged position can include means for constraining the axial movement of the flange member of the bushing along the longitudinal axis of the hub relative to the backing plate in the engaged position.

In embodiments, it is contemplated that the means for constraining the axial movement of the flange member of the bushing along the longitudinal axis of the hub relative to the backing plate in the engaged position comprises a snap-ring spring member that is configured to be received within a backing plate slot defined within the backing plate. In this aspect, it is contemplated that, when seated in the backing plate slot, an inner diameter of the snap-ring spring member is less than an outer diameter of the flange member of the bushing such that the snap-ring spring member acts to constrain the flange member of the bushing between the shoulder surface of the backing plate and the snap-ring spring member of the bushing and to constrain the axial movement of the flange member of the bushing relative to the backing plate.

As shown, the wall member of the backing plate can define a second bore that is positioned co-axially relative to the axis of the central bore and that has a diameter that is greater than the diameter of the central bore. In this aspect, the inner surface of the wall member defines the backing plate slot proximate the distal edge of the backing plate. In embodiments, the backing plate slot extends circumferentially in a plane that is positioned transverse to the axis of the central bore of the backing plate and further can be spaced from the shoulder surface of the backing plate at a desired distance that is at least the width of the flange member of the bushing.

In embodiments, it is contemplated that the means for constraining the axial movement of the flange member of the bushing along the longitudinal axis of the hub relative to the backing plate in the engaged position comprises a plurality of mount fasteners that are configured to mount the flange member of the bushing at a desired distance from a shoulder surface of the backing plate. In this aspect, the backing plate can further define a plurality of mount bores that are spaced about and from the central bore and that extend through the backing plate to open thereon the shoulder surface. It is contemplated that each mount bore can be configured for threaded receipt of a respective mount fastener.

In embodiments, and without limitation, it is contemplated that a method of coupling a driven output shaft into operative engagement with a gearbox having an input shaft and a gear train in geared communication with the input shaft can include the steps of: positioning a flange member of a bushing proximate a shoulder surface of a backing plate; mounting a snap-ring member in a slot defined in a wall member of the backing plate to constrain the flange member of the bushing between the shoulder surface of the backing plate and the snap-ring spring member; and positioning the coupled bushing and backing plate onto a distal end of the driven output shaft at a desired final position. In this aspect, in the desired final position, a bushing slot of the bushing that extend from a distal end of a tapered body portion of the bushing to proximate a bottom surface of the flange member is positioned to overlie an elongated keyway defined in a distal portion of the driven output shaft.

The method can further include the steps of positioning a key member through the bushing slot of the bushing and into the keyway of the driven member such that an upper edge of the key member extends a desired distance therefrom an outer surface of the bushing proximate the keyway; introducing the bushing, the key member and the distal portion of the driven output shaft therein a proximal taper portion of a hub bore defined in a hub such that the key member is aligned for complementary introduction with the hub slot defined in the inner surface of the hub bore; and engaging the backing plate to axially move the backing plate relative to a proximal end of the hub and into an engaged position relative to the hub by threading the backing plate thereon a threaded surface of the proximal end of the hub for operative threaded engagement with the complementary threaded surface on an inner surface of a central bore of the backing plate.

Thus, in the engaged position, the described method constrains axial movement of the bushing and the driven output shaft toward the distal end of the hub. Further, as a result of a portion of the key member being operably positioned within the hub slot, rotative movement of the hub by movement of the gear train causes direct and synchronous rotative movement of the operably coupled bushing, backing plate, and driven output shaft is provided by the described method.

In embodiments, the described method can further include the step of separating the backing plate and the coupled bushing from the proximal end of the hub by engaging the backing plate to axially move the backing plate proximally away from the proximal end of the hub and away from the engaged position relative to the hub to separate the backing plate and the coupled bushing from the hub.

In optional embodiments, the described method can further include the steps of removing the snap-ring spring member from the bushing and urging the flange member of the bushing proximally relative to the shoulder surface of the backing plate to remove the bushing and the driven output shaft from operative contact with the hub.

In optional embodiments, the described method can further include the steps of removing the snap-ring spring member from the bushing; driving a complementarily threaded fastener though a threaded aperture of the flange member such that a distal end of the complementarily threaded fastener can apply compressive force thereon the underlying shoulder surface of the backing plate when the fastener is threadedly urged distally relative to a bottom surface of the flange member; and urging the flange member of the bushing proximally relative to the shoulder surface of the backing plate to remove the bushing and the driven output shaft from operative contact with the hub.

In embodiments, and without limitation, it is contemplated that a method of coupling a driven output shaft into operative engagement with a gearbox having an input shaft and a gear train in geared communication with the input shaft can include the steps of: threadably engaging a backing plate thereon a threaded surface of a proximal end of a hub for operative threaded engagement with a complementary threaded surface on an inner surface of a central bore of the backing plate to axially move the backing plate relative to the proximal end of the hub and into a desired position relative to the hub; positioning a bushing onto a distal end of a driven output shaft at a desired final position, wherein, in the desired final position, a bushing slot of the bushing extends from the distal end of the tapered body portion of the bushing to proximate a bottom surface of a flange member of the bushing is positioned to overlie an elongated keyway defined in the distal portion of the driven output shaft; and positioning a key member through the bushing slot of the bushing and into the keyway of the driven member such that an upper edge of the key member extends a desired distance therefrom an outer surface of the bushing proximate the keyway.

The method can further include the steps of introducing the bushing, the key member and the distal portion of the driven output shaft therein a proximal taper portion of a hub bore defined in the hub such that the key member is aligned for complementary introduction with the hub slot defined in the inner surface of the hub bore; and mounting a plurality of mount fasteners though respective flange bores defined in the flange member of the bushing and into operative threaded engagement with respective complementary mount bores defined in the backing plate to axially constrain the flange member of the bushing relative to the shoulder surface of the backing plate. It is contemplated that, in the engaged position, movement of the bushing and the driven output shaft is constrained from axial movement toward the distal end of the hub and, as a result of a portion of the key member being operably positioned within the hub slot, rotative movement of the hub by movement of the gear train causes direct and synchronous rotative movement of the operably coupled bushing, backing plate, and driven output shaft.

In embodiments, the described method can further include the step of separating the bushing from the backing plate positioned on the proximal end of the hub by removing the mount fasteners from operative threaded communication with the respective complementary mount bores in the backing plate and urging the flange member of the bushing to axially move the flange member proximally and away from the shoulder surface of the backing member until the bushing and the driven output shaft are separated from the hub.

In optional embodiments, the described method can further include the steps of separating the bushing from the backing plate positioned on the proximal end of the hub by removing the mount fasteners from operative threaded communication with the respective complementary mount bores in the backing plate; driving a complementarily threaded fastener though a threaded aperture of the flange member such that a distal end of the complementarily threaded fastener can apply compressive force thereon the underlying shoulder surface of the backing plate when the fastener is threadedly urged distally relative to a bottom surface of the flange member; and urging the flange member of the bushing to axially move the flange member proximally relative to the shoulder surface of the backing plate to remove the bushing and the driven output shaft from operative contact with the hub.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims.

What is claimed:

1. A power transmission system in communication with a gearbox having an input shaft and a gear train in geared communication with the input shaft, comprising:
a driven output shaft having a distal portion defining an elongated keyway configured to receive a key member;
a hub configured for geared communication with the gear train of the gearbox, the hub defining a hub bore that extends therethrough the hub from a proximal end to a distal end along a longitudinal axis of the hub, wherein the hub bore has a proximal taper portion forming an interior wall that is tapered inwardly from the proximal end of the hub until reaching a first uniform diameter portion of the hub bore, wherein the interior wall of the proximal taper portion is formed at an acute taper angle α relative to the longitudinal axis of the hub, wherein an exterior surface of the proximal end of the hub includes a threaded surface, and wherein the hub defines a hub slot in the inner surface of the bore that extends along a plane that is co-axial to the longitudinal axis of the hub, which is sized and shape for receipt of the upper edge portion the key member;
a backing plate having a shoulder surface and a wall member integrally connected to an edge of the backing plate and extending distally to a distal edge such that the backing plate has a general cup shape in cross-section, the backing plate defining a central bore that extends through the backing plate and has a diameter allowing the backing plate to be slideably received thereon the distal portion of the driven output shaft, wherein an inner surface of the central bore forms a threaded surface that is configured for selective operative threaded engagement with the complementary threaded surface on the exterior surface of the proximal end of the hub;
a bushing having a flange member and an integrally coupled tapered body portion that extends distally therefrom the flange member, wherein the flange member and the inner surface of the tapered body portion defines a bushing bore that is shaped and sized for complementary receipt thereon the exterior surface of the distal portion of the driven output shaft, wherein the tapered body portion of the bushing has an outer surface having a maximum outer diameter proximate a distally facing surface of the flange member that is configured to taper to a minimum outer diameter at a distal end of the tapered body portion, wherein the outer surface of the tapered body portion is formed at an acute taper angle β with respect to the longitudinal axis of the bushing, wherein the acute taper angle β the outer surface of the tapered body portion of the bushing is substantially the same as the acute taper angle α of the interior wall of the proximal taper portion of the hub bore to allow for complementary engagement of the interior wall of the proximal taper portion of the hub bore with the outer surface of the tapered body portion of the bushing in an engaged position, wherein the tapered body portion of the bushing defines a bushing slot that extends from the distal end of the tapered body portion to proximate the flange member that is sized and shaped for receipt of the key member, and wherein, in the engaged position, portions of the inner surface of the tapered body portion of the bushing are configured to frictionally engage underlying portions of the exterior surface of the distal portion of the driven output shaft; and
a means for constraining the axial movement of the flange member of the bushing along the longitudinal axis of the hub relative to the backing plate in the engaged position,
wherein, in the engaged position, an upper edge portion of the key member extends from the keyway of the driven output shaft through the bushing slot and into engagement with the hub slot such that rotative movement of the hub causes direct and synchronous rotative movement of the operably coupled bushing, backing plate, and driven output shaft.

2. The power transmission system of claim 1, wherein the means for constraining the axial movement of the flange member of the bushing along the longitudinal axis of the hub relative to the backing plate in the engaged position comprises a snap-ring spring member that is configured to be received within a backing plate slot defined within the backing plate.

3. The power transmission system of claim 2, wherein, when seated in the backing plate slot, an inner diameter of the snap-ring spring member is less than an outer diameter of the flange member of the bushing such that the snap-ring spring member acts to constrain the flange member of the bushing between the shoulder surface of the backing plate and the snap-ring spring member of the bushing and to constrain the axial movement of the flange member of the bushing relative to the backing plate.

4. The power transmission system of claim 3, wherein the wall member of the backing plate defines a second bore that is positioned co-axially relative to the axis of the central bore and that has a diameter that is greater than the diameter of the central bore, wherein the inner surface of the wall member defines the backing plate slot proximate the distal edge of the backing plate.

5. The power transmission system of claim 4, wherein the backing plate slot extends circumferentially in a plane that is positioned transverse to the axis of the central bore of the backing plate.

6. The power transmission system of claim 5, wherein the backing plate slot is spaced from the shoulder surface of the backing plate at a desired distance that is at least the width of the flange member of the bushing.

7. The power transmission system of claim 1, wherein the means for constraining the axial movement of the flange member of the bushing along the longitudinal axis of the hub relative to the backing plate in the engaged position comprises a plurality of mount fasteners that are configured to mount the flange member of the bushing at a desired distance from a shoulder surface of the backing plate.

8. The power transmission system of claim 7, wherein the backing plate further defines a plurality of mount bores that are spaced about and from the central bore and that extend through the backing plate to open thereon the shoulder surface, and wherein each mount bore is configured for threaded receipt of a respective mount fastener.

9. The power transmission system of claim 1, wherein the elongated keyway extends parallel to a longitudinal axis of the driven output shaft from the distal end of the driven output shaft to a second stop that is spaced from the distal end of the driven output shaft.

10. The power transmission system of claim 1, wherein the tapered body portion of the bushing defines a slit extending from proximate the bottom surface of the flange member to the distal end of the tapered body portion to allow for an operative reduction in diameter of the bushing bore as the bushing is urged into the engaged position.

11. The power transmission system of claim 1, wherein the hub bore has a second uniform diameter portion that extends from the first uniform diameter portion to the distal end of the hub, and wherein the diameter of the second uniform diameter portion exceeds the diameter of the distal portion of the driven output shaft by a space tolerance of between about 0.0015″ to about 0.0075″.

12. The power transmission system of claim 1, wherein the respective complementary threaded surfaces formed on the inner surface of the central bore and the exterior surface of the proximal end of the hub have a thread pitch having a threads-per-inch (TPI) that is between about 6 to about 16.

13. The power transmission system of claim 1, further comprising a cap member configured to mount to a distal end of the hub.

14. The power transmission system of claim 1, wherein the flange member further defines at least one threaded aperture that extends therethrough the flange member, and wherein, when in the engaged position, the at least one aperture overlies the shoulder surface of the backing plate.

15. A power transmission system in communication with a driven output shaft having a distal portion defining an elongated keyway configured to receive a key member and with a gearbox having an input shaft and a gear train in geared communication with the input shaft, comprising:
a hub configured for geared communication with the gear train of the gearbox, the hub defining a hub bore that extends therethrough the hub from a proximal end to a distal end along a longitudinal axis of the hub, wherein the hub bore has a proximal taper portion forming an interior wall that is tapered inwardly from the proximal end of the hub until reaching a first uniform diameter portion of the hub bore, wherein an exterior surface of the proximal end of the hub includes a threaded surface;
a backing plate having a shoulder surface and a wall member integrally connected to an edge of the backing plate and extending distally to a distal edge such that the backing plate has a general cup shape in cross-section, the backing plate defining a central bore that extends through the backing plate, wherein an inner surface of the central bore forms a threaded surface that is configured for selective operative threaded engagement with the complementary threaded surface on the exterior surface of the proximal end of the hub;
a bushing having a flange member and an integrally coupled tapered body portion that extends distally therefrom the flange member, wherein the flange member and the inner surface of the tapered body portion defines a bushing bore that is shaped and sized for complementary receipt thereon the exterior surface of the distal portion of the driven output shaft, wherein the hub defines a hub slot in the inner surface of the bore, wherein the tapered body portion of the bushing has an outer surface formed to allow for complementary engagement of the interior wall of the proximal taper portion of the hub bore with the outer surface of the tapered body portion of the bushing in an engaged position, and wherein, in the engaged position, portions of the inner surface of the tapered body portion of the bushing are configured to frictionally engage underlying portions of the exterior surface of the distal portion of the driven output shaft; and
a means for constraining the axial movement of the flange member of the bushing along the longitudinal axis of the hub relative to the backing plate in the engaged position,
wherein, in the engaged position, an upper edge portion of the key member extends from the keyway of the driven output shaft through the bushing slot and into engagement with the hub such that rotative movement of the hub causes direct and synchronous rotative movement of the operably coupled bushing, backing plate, and driven output shaft.

16. The power transmission system of claim 15, wherein the interior wall of the proximal taper portion is formed at an acute taper angle α relative to the longitudinal axis of the hub.

17. The power transmission system of claim 16, wherein the outer surface of the tapered body portion is formed at an acute taper angle β with respect to the longitudinal axis of the bushing, and wherein the acute taper angle β of the outer surface of the tapered body portion of the bushing is be substantially the same as the acute taper angle α of the interior wall of the proximal taper portion of the hub bore.

18. The power transmission system of claim 15, wherein the hub slot extends along a plane that is co-axial to the longitudinal axis of the hub, which is sized and shaped for receipt of the upper edge portion the key member.

19. The power transmission system of claim 15, wherein the central bore of the backing plate has a diameter allowing the backing plate to be slideably received thereon the distal portion of the driven output shaft.

20. The power transmission system of claim 15, wherein the outer surface of the tapered body portion of the bushing has a maximum outer diameter proximate a distally facing surface of the flange member that is configured to taper to a minimum outer diameter at a distal end of the tapered body portion.

21. The power transmission system of claim 15, wherein the tapered body portion of the bushing defines a bushing slot that extends from the distal end of the tapered body portion to proximate the flange member that is sized and shape for receipt of the key member.

22. A method of coupling a driven output shaft into operative engagement with a gearbox having an input shaft and a gear train in geared communication with the input shaft, comprising:
positioning a flange member of a bushing proximate a shoulder surface of a backing plate;
mounting a snap-ring member in a slot defined in a wall member of the backing plate to constrain the flange member of the bushing between the shoulder surface of the backing plate and the snap-ring spring member;
positioning the coupled bushing and backing plate onto a distal end of the driven output shaft at a desired final position, wherein, in the desired final position, a bushing slot of the bushing extends from a distal end of a tapered body portion of the bushing to proximate a bottom surface of the flange member is positioned to overlie an elongated keyway defined in a distal portion of the driven output shaft;
positioning a key member through the bushing slot of the bushing and into the keyway of the driven member such that an upper edge of the key member extends a desired distance therefrom an outer surface of the bushing proximate the keyway;
introducing the bushing, the key member and the distal portion of the driven output shaft therein a proximal taper portion of a hub bore defined in a hub such that the key member is aligned for complementary introduction with the hub slot defined in the inner surface of the hub bore; and
engaging the backing plate to axially move the backing plate relative to a proximal end of the hub and into an engaged position relative to the hub by threading the backing plate thereon a threaded surface of the proximal end of the hub for operative threaded engagement with the complementary threaded surface on an inner surface of a central bore of the backing plate,
wherein, in the engaged position, movement of the bushing and the driven output shaft is constrained from axial movement toward the distal end of the hub and, as a result of a portion of the key member being operably positioned within the hub slot, rotative movement of the hub by movement of the gear train causes direct and synchronous rotative movement of the operably coupled bushing, backing plate, and driven output shaft.

23. The method of claim 22, further comprising:
separating the backing plate and the coupled bushing from the proximal end of the hub by engaging the backing plate to axially move the backing plate proximally away from the proximal end of the hub and away from the engaged position relative to the hub to separate the backing plate and the coupled bushing from the hub.

24. The method of claim 22, further comprising:
removing the snap-ring spring member from the bushing;
urging the flange member of the bushing proximally relative to the shoulder surface of the backing plate to remove the bushing and the driven output shaft from operative contact with the hub.

25. The method of claim 22, further comprising:
removing the snap-ring spring member from the bushing;
driving a complementarily threaded fastener though a threaded aperture of the flange member such that a distal end of the complementarily threaded fastener will apply compressive force thereon the underlying shoulder surface of the backing plate when the fastener is threadedly urged distally relative to a bottom surface of the flange member; and
urging the flange member of the bushing proximally relative to the shoulder surface of the backing plate to remove the bushing and the driven output shaft from operative contact with the hub.

26. A method of coupling a driven output shaft into operative engagement with a gearbox having an input shaft and a gear train in geared communication with the input shaft, comprising:
threadably engaging a backing plate thereon a threaded surface of a proximal end of a hub for operative threaded engagement with a complementary threaded surface on an inner surface of a central bore of the backing plate to axially move the backing plate relative to the proximal end of the hub and into a desired position relative to the hub;
positioning a bushing onto a distal end of a driven output shaft at a desired final position, wherein, in the desired final position, a bushing slot of the bushing extends from the distal end of the tapered body portion of the bushing to proximate a bottom surface of a flange member of the bushing is positioned to overlie an elongated keyway defined in the distal portion of the driven output shaft;
positioning a key member through the bushing slot of the bushing and into the keyway of the driven member such that an upper edge of the key member extends a desired distance therefrom an outer surface of the bushing proximate the keyway;
introducing the bushing, the key member and the distal portion of the driven output shaft therein a proximal taper portion of a hub bore defined in the hub such that the key member is aligned for complementary introduction with the hub slot defined in the inner surface of the hub bore; and
mounting a plurality of mount fasteners though respective flange bores defined in the flange member of the bushing and into operative threaded engagement with respective complementary mount bores defined in the backing plate to axially constrain the flange member of the bushing relative to the shoulder surface of the backing plate;
wherein, in the engaged position, movement of the bushing and the driven output shaft is constrained from axial movement toward the distal end of the hub and, as a result of a portion of the key member being operably positioned within the hub slot, rotative movement of the hub by movement of the gear train causes direct and synchronous rotative movement of the operably coupled bushing, backing plate, and driven output shaft.

27. The method of claim 26, further comprising:
separating the bushing from the backing plate positioned on the proximal end of the hub by removing the mount fasteners from operative threaded communication with the respective complementary mount bores in the backing plate; and
urging the flange member of the bushing to axially move the flange member proximally and away from the shoulder surface of the backing member until the bushing and the driven output shaft are separated from the hub.

28. The method of claim 26, further comprising:
separating the bushing from the backing plate positioned on the proximal end of the hub by removing the mount fasteners from operative threaded communication with the respective complementary mount bores in the backing plate;
driving a complementarily threaded fastener though a threaded aperture of the flange member such that a distal end of the complementarily threaded fastener will apply compressive force thereon the underlying shoulder surface of the backing plate when the fastener is threadedly urged distally relative to a bottom surface of the flange member; and
urging the flange member of the bushing to axially move the flange member proximally relative to the shoulder surface of the backing plate to remove the bushing and the driven output shaft from operative contact with the hub.
